(19) United States
(12) Patent Application Publication
(10) Pub. No.: US 2015/0286391 A1
(43) Pub. Date: Oct. 8, 2015

(54) SYSTEM AND METHOD FOR SMART WATCH NAVIGATION

(71) Applicant: Olio Devices, Inc., San Francisco, CA (US)

(72) Inventors: Steven Jacobs, San Francisco, CA (US); Bruce Trip Vest, San Francisco, CA (US); Kyle Dell'Aquila, San Francisco, CA (US); Evan Wilson, San Francisco, CA (US); AJ Cooper, San Francisco, CA (US); Michael Miller, San Francisco, CA (US); Michael Smith, San Francisco, CA (US)

(21) Appl. No.: 14/644,748

(22) Filed: Mar. 11, 2015

Related U.S. Application Data
(60) Provisional application No. 61/976,922, filed on Apr. 8, 2014.

(51) Int. Cl. G06F 3/0484

(52) U.S. Cl. CPC G06F 3/04847; G06F 3/04845; G06F 3/04842

(57) ABSTRACT

A method for smartwatch control, including: displaying content from a first content stream at face of the smartwatch, the face including a touchscreen coaxially arranged with a display; tracking a user gesture at the touchscreen; in response to user gesture categorization as a radially inward gesture, setting a second content stream as active, wherein the second content stream is different from the first content stream; and in response to user gesture categorization as a radially outward gesture, determining a direction of the user gesture, in response to the direction being a first direction, performing a positive action on the displayed content and in response to the direction being a second direction opposing the first, performing a negative action on the displayed content.

### CROSS-REFERENCE TO RELATED APPLICATIONS

This application claims the benefit of U.S. Provisional Application No. 61/976,922 filed 8 Apr. 2014, which is incorporated in its entirety by this reference. This application is related to application Ser. No. 14/513,054 filed 13 Oct. 2014, which is incorporated in its entirety by this reference.

### TECHNICAL FIELD

This invention relates generally to the portable device field, and more specifically to a new and useful system and method for smart watch navigation in the portable device field.

### BRIEF DESCRIPTION OF THE FIGURES

FIG. 1 is a schematic representation of a variation of the displayed portion of the virtual space, with solid lines representing the portion of the space that is rendered on the display area, and the dashed lines representing what is not rendered on the display area.

FIG. 2 is a schematic representation of a variation of the display area including a text area and a remainder area in which card portions are rendered.

FIG. 3 is a schematic representation of a variation of the device including a data input area and a display area with an imaginary central point, a first and second imaginary axis, and a virtual threshold tracing the perimeter of the display area.

FIG. 4 is a schematic representation of a variety of vector interactions.

FIG. 5 is a schematic representation of a first virtual structure variation.

FIG. 6 is a schematic representation of a second virtual structure variation.

FIG. 7 is a schematic representation of a first variation of an active collection indicator.

FIG. 8 is a schematic representation of a first variation of navigation between card collections including a second variation of an active collection indicator.

FIG. 9 is a schematic representation of a second variation of navigation between card collections.

FIG. 10 is a schematic representation of a first specific example of the system and method.

FIG. 11 is a schematic representation of a second specific example of the system and method.

FIG. 12 is a schematic representation of a third specific example of the system and method including a context-based card.

FIGS. 13A and 13B are schematic representations of a fourth specific example of the system and method in a first context and a second context, respectively.

FIG. 14 is a schematic representation of a specific example of interaction-to-action mapping based on the active card.

FIG. 15 is a schematic representation of a second specific example of interaction-to-action mapping based on the active card.

FIG. 16 is a schematic representation of a third specific example of interaction-to-action mapping based on the active card and context.

FIG. 17 is a schematic representation of an example of a virtual structure including a past collection, future collection, and default collection of content.

FIG. 18 is a schematic representation of an example of interaction-to-action mapping.

FIG. 19 is a schematic representation of providing a background based on parameters of a secondary content collection for a home card.

FIGS. 20A and 20B are an isometric and cutaway view of an example of the device.

FIG. 21 is a schematic representation of a specific example of the method, including opening a list of action options in response to receipt of a radially outward gesture having a velocity below a threshold velocity and automatically performing a stored action in response to receipt of a radially outward gesture having a velocity above a threshold velocity.

FIG. 22 is a schematic representation of a specific example of notifying the user of a piece of content, setting the respective collection or stream as active in response to determination of user interest in the display within a threshold period of time, and maintaining the default collection as active in response to the absence of user interest in the display within the threshold period of time.

FIG. 23 is a schematic representation of the method of device control.

FIGS. 24A-24C are examples of a home card with a background automatically and dynamically generated based on a parameter of a secondary collection.

FIGS. 25A and 25B are examples of secondary cards in the home collection.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

1. Method.

As shown in FIG. 23, the method includes receiving a user interaction on a device input S100, analyzing the parameters of the interaction S200, identifying an action mapped to the interaction based on the parameters of the interaction S300, and applying the action to the information represented by the content S400. The method functions to enable gesture-based management of a device control system.

a. Device.

The method is preferably utilized with a portable device 100, which functions to perform the method. The portable device 100 preferably has a first and a second opposing broad face. The portable device 100 is preferably a watch (e.g., as shown in FIGS. 20A and 20B), more preferably an actively controlled watch face 120, but can alternatively be any other suitable device 100. The portable device 100 preferably includes a watch face including a display 120 and a data input 140, and can additionally include sensors (e.g., orientation sensor, such as an accelerometer or gyroscope, proximity sensor, sound sensor, light sensor, front facing camera, back facing camera, etc.), transmitters and/or receivers (e.g., WiFi, Zigbee, Bluetooth, NFC, RF, etc.), a power source, or any other suitable component. The portable device 100 can additionally include alignment features, such as that disclosed in Ser. No. 14/513,054 filed 13 Oct. 2014, incorporated herein in its entirety by this reference, or any other suitable alignment or keying feature, wherein the position of the alignment features on the device 100 can additionally function to define one or more virtual reference axes.

The portable device 100 is preferably limited in size (e.g., less than five inches in diameter, more preferably less than three inches in diameter), but can alternatively have any other suitable dimensions. The portable device 100, more preferably the face but alternatively any other suitable component of the device 100 (e.g., display 120, touchscreen), can have a symmetric profile (e.g., about a lateral axis, longitudinal axis, radial axis), asymmetric profile, or any other suitable profile. In one variation, the portable device component has a radially symmetric profile about a central axis, wherein the central axis can be perpendicular to the broad face of the portable device 100 or component. The portable device 100 preferably has a substantially circular profile, but can alternatively have a regular polygonal profile (e.g., rectangular, octagonal, etc.).

The portable device 100 preferably communicates (e.g., wirelessly) with a secondary device, such as a smartphone, tablet, laptop, or other computing device. The secondary device can communicate data (e.g., operation instructions, data processing instructions, measurements, etc.) directly with the portable device 100, or can communicate with the portable device 100 through a remote server or local network, wherein the remote server or local network functions as an intermediary communication point. The portable device 100 preferably receives notifications from the secondary device. The portable device 100 can control secondary device functionalities (e.g., instruct the secondary device to render content). The portable device 100 can additionally request measurements from the secondary device. The secondary device can control portable device 100 functionalities directly or indirectly (e.g., determines an context for the user, wherein the card collection 20s displayed on the portable device 100 are based on the determined context). The secondary device preferably receives (e.g., from a remote server) or generates content, such as messages, audio, video, and notifications, and can additionally send the content to the portable device 100. The portable device 100 preferably compacts the content (e.g., shortens the content, selects a subset of the content for display 120, etc.), but the secondary device can alternatively compact the content and send the compacted content to the portable device 100. In one example, in response to receipt of a gesture on the device 100, the device 100 generates a control instruction for a set of secondary devices (e.g., one or more smartphones, tablets, televisions, or laptops) and sends the control instruction directly or indirectly to the set of secondary devices. However, the portable device 100 can interact with the secondary device in any other suitable manner.

The display 120 functions to render images, text, or any other suitable visual content. The display 120 is preferably arranged on the first broad face of the device 100, and can additionally cover the sides and/or the second broad face of the device 100. The display 120 preferably covers a portion of the first broad face (e.g., less than the entirety of the first broad face), but can alternatively cover the entire broad face. The display 120 preferably has a profile similar or the same as that of the device 100 perimeter (e.g., perimeter of the first broad face), but can alternatively have any other suitably shaped perimeter. The display 120 is preferably arranged underneath the touchscreen, but can alternatively be positioned in any other suitable position. The display 120 is preferably concentric with the device 100 broad face, but can alternatively be coaxially arranged with the face, offset from the device 100 broad face, or otherwise arranged. The display 120 is preferably concentrically arranged with the touchscreen, but can alternatively be coaxially arranged with the touchscreen, offset from the touchscreen, or otherwise arranged. The display 120 or visible portion thereof can be smaller than the touchscreen (e.g., in diameter or radius), larger than the touchscreen, the same size as the touchscreen, or have any other suitable size relative to the touchscreen. The display 120 can be radially symmetric, symmetric about a longitudinal face axis, symmetric about a lateral face axis, or have any other suitable configuration. The display 120 can be a LED display 120, OLED display 120, LCD display 120, or any other suitable display 120.

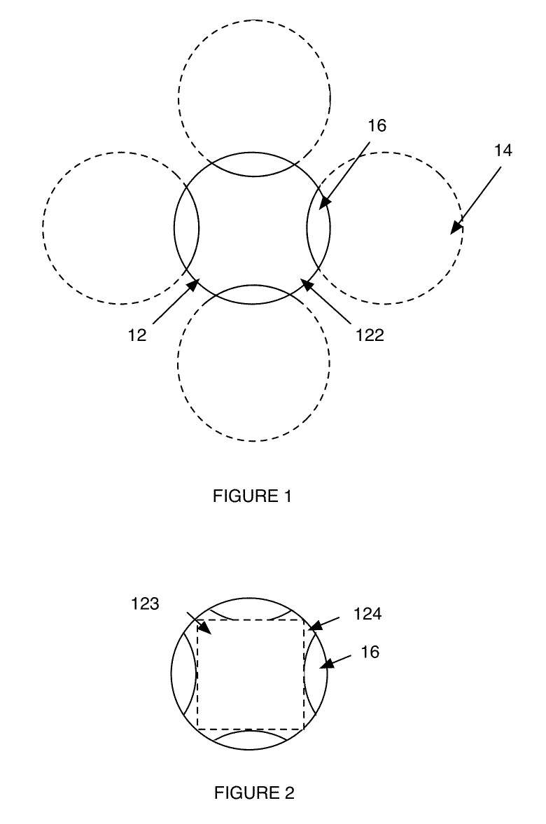

As shown in FIG. 1, the display area 122 preferably defines a text area 123 and a remainder area 124. As shown in FIG. 2, the text area preferably functions to display content from applications (both native and third party), more preferably card 10 content, and the remainder area (e.g., the portion of the display area 122 not occupied by the text area) is preferably used to display card indicators, wherein the card indicators are preferably indicative of inactive card 10s, more preferably of inactive card 10s adjacent the active card 10. Alternatively, the text area can occupy the entirety of the display area 122, wherein the card indicators are rendered within the text area. The text area is preferably rectilinear, more preferably square, but can alternatively have any other suitable profile. The text area is preferably fully encompassed by the display area 122, but can alternatively be larger than the display area 122. A standardized text area, such as a rectilinear text area, can be desirable for developer standardization and adoption purposes. The rectilinear text area is preferably arranged aligned relative to the first and second imaginary axes, such that the lateral axis of the text area is arranged parallel to the first imaginary axis 104 and the longitudinal axis of the text area is arranged parallel to the second imaginary axis 106. Text is preferably displayed parallel to the first imaginary axis 104, but can be otherwise arranged.

The data input 140 is preferably a touch sensor (e.g., a capacitive or resistive touch screen) overlaid on the display 120, but can alternatively be a mouse, gesture sensor, keyboard, or any other suitable data input 140. The data input 140 preferably has the same profile as the device 100, and is preferably concentric with the first broad face boundaries, but can alternatively have a different profile from the device 100. The data input 140 preferably covers the entirety of the first broad face, but can alternatively cover a subset of the first broad face, the first broad face and the adjacent edges, or any other suitable portion of the portable device 100. The data input 140 is preferably larger than and encompasses the display 120, but can alternatively be smaller than or the same size as the display 120. The data input 140 is preferably concentric with the display area 122, but can alternatively be offset from the display area 122. Each unit of the data input 140 area is preferably mapped to a display 120 unit (e.g., pixel). Alternatively, the data input 140 and display 120 unit can be decoupled.

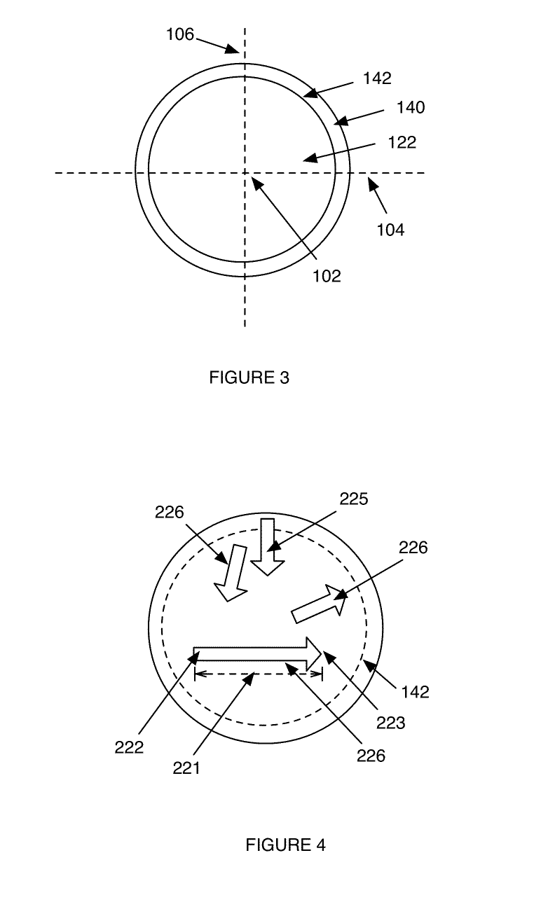

The display 120 input area can additionally includes a virtual threshold 142 that functions as a reference point for gestures. As shown in FIG. 3, the virtual threshold 142 preferably traces the perimeter of the display area 122 (e.g., delineates the perimeter of the display area 122), more preferably the perimeter of the visible display area 122, but can alternatively trace the edge of the input area, encircle a portion of the display area 122 (e.g., be concentrically arranged within the display area 122), be a cord across a segment of the input area, be a border of the touch screen, or be otherwise defined. The device 100 can additionally or alternatively include a touch-sensitive bezel or any other input component.

The display 120 and/or input area can additionally include an imaginary central point. The display 120 and/or input area can additionally include an imaginary axis 104. The imaginary axis 104 (e.g., imaginary first axis 104) is preferably predetermined, but can alternatively be dynamically determined based on an accelerometer within the device 100. For example, the imaginary axis 104 can be defined as a normal vector to a projection of the measured gravity vector onto the plane of the display 120 or input broad face. However, the imaginary axis 104 can be otherwise defined. A secondary imaginary axis 104 can additionally be defined, wherein the secondary imaginary axis 104 is preferably perpendicular to the imaginary axis 104 along the plane of the display 120 or input broad face, but can alternatively be at any other suitable angle relative to the first imaginary axis 104 or gravity vector. A third imaginary axis 104 can additionally be defined relative to the broad face, wherein the third imaginary axis 104 preferably extends at a normal angle to the broad face. The third imaginary axis 104 preferably intersects the imaginary center point 102 of the device 100, but can alternatively intersect the device 100 at any other suitable point.

The device 100 can additionally include a second data input 140, which can function to change the functionality of the device 100 (e.g., change which set of actions are mapped to which set of gestures). For example, the second data input 140 can be a bezel encircling the display 120 and data input 140 that rotates about the center point. However, any other suitable data input 140 can be used. The device 100 can additionally include a position or motion sensor (e.g., an accelerometer or gyroscope), a light sensor, a transmitter and receiver (e.g., to communicate with a second portable device 100, such as a smart phone, tablet, or laptop), a microphone, or any other suitable component.

The portion of the display area 122 rendering the card indicator is preferably associated with the respective virtual card 10. The portion of the input area corresponding to the mapped display area 122 is also preferably mapped to the virtual card 10. The portion of the input area that is enclosed by a first and second vector extending radially outward from the center point and intersecting a first and second point of intersection between the display area 122 perimeter and the adjacent card 10 perimeter, respectively, can additionally be mapped to the adjacent card 10. Alternatively, the area of the data input 140 that the adjacent card 10 would enclose, but is not displayed, is also mapped to the adjacent card 10).

b. Virtual Content Structure and Organization.

The method functions to navigate a display area within a virtual structure 30. The virtual structure 30 preferably includes one or more cards 10, wherein each card 10 is preferably associated with one or more pieces of information. The cards 10 can alternatively be associated with other cards 10 in any other suitable manner. Alternatively or additionally, the virtual structure 30 can include one or more card collections 20, each including a set of cards 10. The virtual structure 30 used to represent a card collection 20 can be determined by the user, predetermined (e.g., by the card collection creator, etc.), based on the context, based on the type of card 10 (e.g., whether the card is an information card or a cover card), or determined in any other suitable manner.

The cards 10 are preferably virtual objects representative of content, but can alternatively be any other suitable virtual representation of digital information. The pieces of information (content) can be lists, streams, messages, notifications, audio tracks, videos, control menus (e.g., a home accessory controller, television controller, music controller, etc.), recommendations or requests (e.g., request to execute an action), or any other suitable piece of content. The card 10 can be operable in a single view, operable between a summary view and a detailed view, or operable between any other suitable set of views. Alternatively or additionally, the piece of information associated with the card 10 can be a collection of cards 10 (e.g., card 10 sets, stream, etc.), wherein the card 10 is a cover card 10.

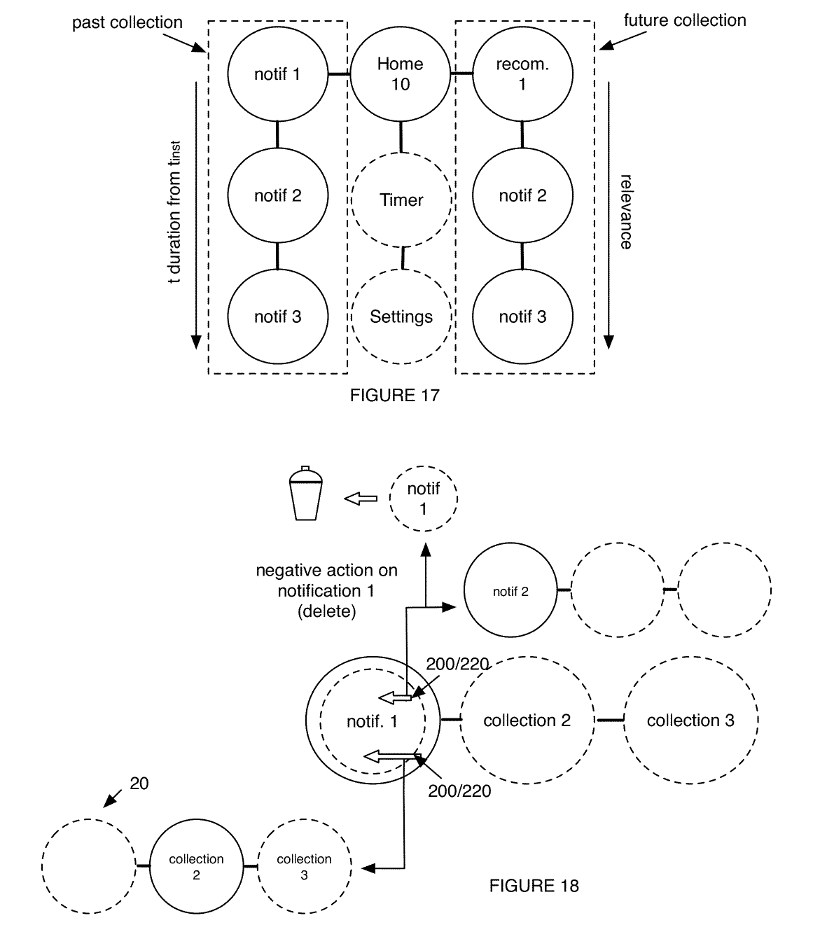

The collection of cards 10 can be organized in the same virtual space as the cover card 10 or in a separate virtual space from the cover card 10. The card collections 20 can be virtually arranged in fixed relation, wherein a first collection 22 can be always arranged adjacent a second collection 24, irrespective of which collection is set as active. The collections can be arranged in linear relation, wherein the virtual position of a first collection is always arranged along a first axis in a first direction relative to a second collection, wherein the second collection is always arranged along the first axis in a second direction opposing the first direction relative to the first collection; circular relation; or in any other suitable relationship. In a specific example, a first collection can always be arranged to the left of a second collection, which is always arranged to the left of a third collection 26, irrespective of which collection is set as active and/or is rendered on the display. For example, as shown in FIG. 17, the first collection can be a past collection, the second collection can be a current collection, and the third collection can be a future collection. Alternatively, the card collection 20 virtual arrangement can be variable. In one variation, the variable collection arrangement can be dynamically determined based on a context parameter, such as time, geographic location, collection parameter (e.g., number of pieces of content in the collection), or any other suitable parameter. In one example, a first collection is arranged to the right of a home or default collection and a second collection is arranged to the left of the home or default collection at loam, while the first collection can be arranged to the left of the home collection and a third collection can be arranged to the right of the home collection. In this variation, the collection proximity to the default or home collection (e.g., collection that the device shows by default, collection that the device shows after being in standby mode, etc.) can be ordered based on a collection parameter (e.g., frequency of content, volume of content, importance, relevance, etc.). Alternatively or additionally, the availability of the collection to the user (e.g., inclusion within the set of collections that can be accessed at that time) can be dependent on the collection parameters. However, the card collections 20 can be otherwise organized.

The card collection 20 can be a category collection, wherein the cards 10 of the collection are cards 10 associated with applications of the same category or genre. For example, a “fitness” collection can include cards 10 associated with fitness applications or devices. Alternatively, the card collection 20 can be an application collection, wherein the cards 10 of the collection are cards 10 associated with functionalities, sub-folders, or content of the application. For example, the cards 10 of an email application can include a “read” cover card 10, an “unread” cover card 10, and a “replied” cover card 10, wherein each cover card 10 is associated with a sub-collection of messages. Alternatively, the card collection 20 can be time-based (e.g., temporally sorted), with a first collection representing past events and a second collection representing future events. Content sorted into the first collection can be associated with a timestamp (e.g., generation timestamp, receipt timestamp, referenced time, etc.) that is before a reference time (e.g., an instantaneous time), generated through an application that is associated with the first collection (e.g., wherein a first set of applications can be only associated with the first collection), or sorted into the first collection based on any other suitable parameter. Examples of content in the first collection include notifications, messages, emails, or any other suitable content. Content sorted into the second collection can be associated with a timestamp after the reference time, generated through an application associated with the second collection, or sorted into the second collection based on any other suitable parameter. Examples of content in the second collection include recommendations (e.g., recommended directions, recommended events, recommended actions, etc.), future events (e.g., future weather information, traffic delay notifications, future calendar events), or any other suitable content associated with a future time.

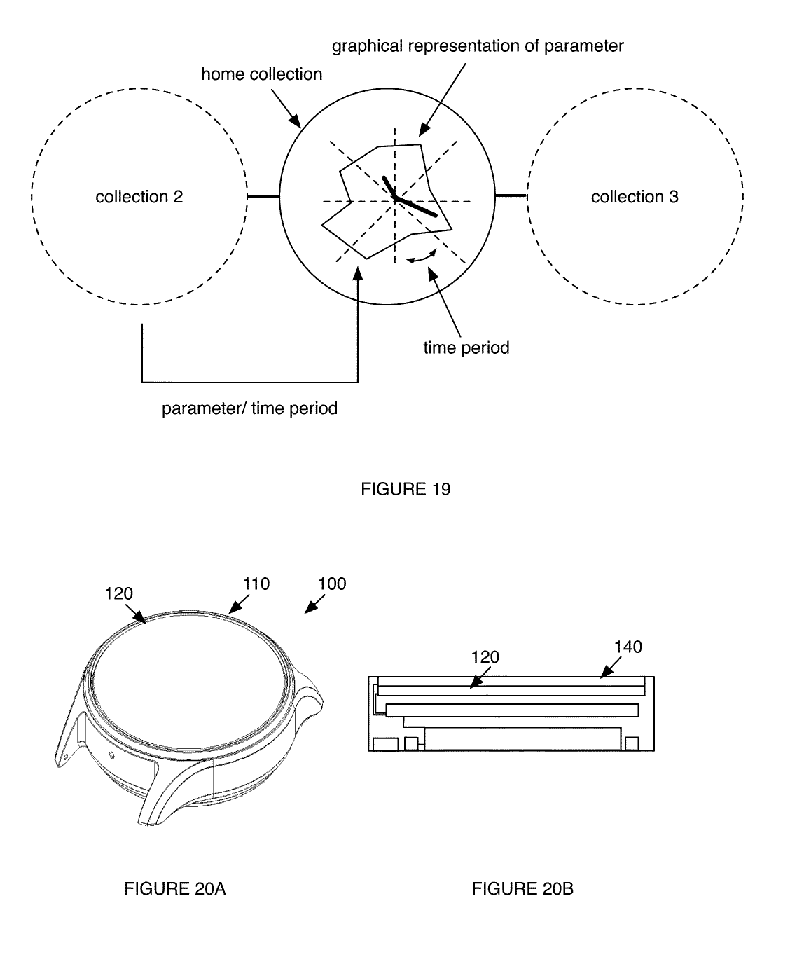

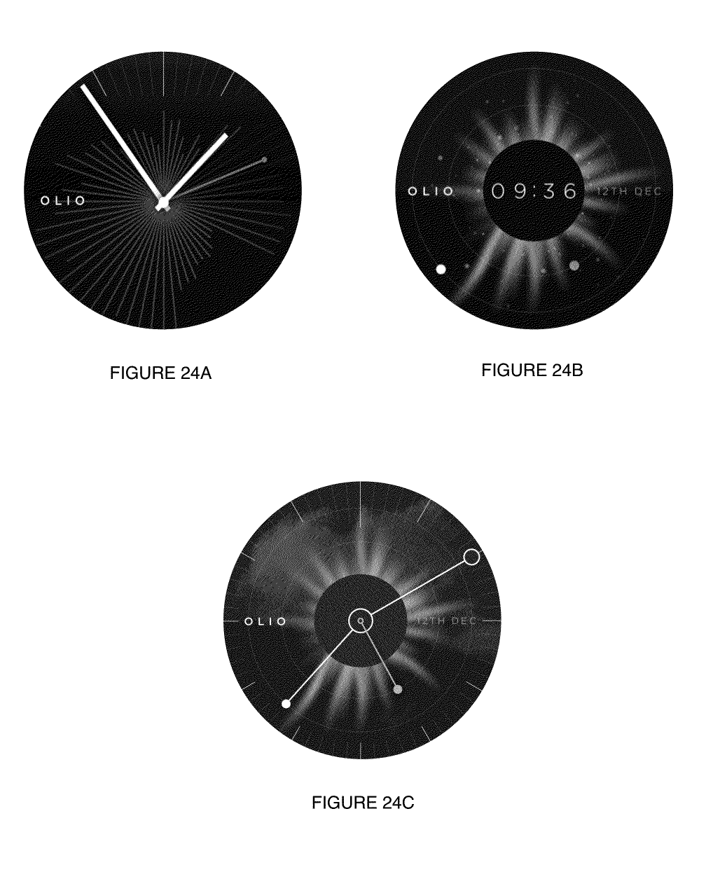

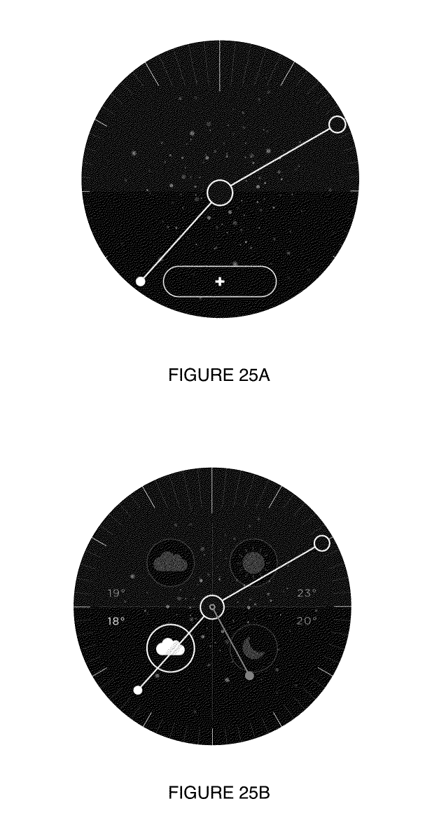

The set of card collections 20 can additionally include a home collection including a set of home cards 10. The home cards 10 can include instantaneous content (e.g., a watch face displaying the current time), past content (e.g., notifications) received within a time period threshold of an instantaneous time, future content (e.g., recommendations) received within a time period threshold of the instantaneous time, native smartwatch functionalities (e.g., settings, timers, alarms etc.), or any other suitable content. The home collection preferably includes a default card 10 to which the display defaults when the device is put to sleep (e.g., when the display is turned off or put into standby mode). The default card 10 preferably displays instantaneous content, but can alternatively or additionally display any other suitable information. In one variation, the default card 10 displays a watch face (e.g., a digital representation of an analog watch). The default card 10 can additionally concurrently display a graphical representation derived from one or more parameters of other card collections 20. The parameters can be stream population parameters (e.g., frequency, volume, percentage of a given card type, etc.), parameters of specific cards (e.g., content of specific cards within the stream, applications generating the card content, etc.), or be any other suitable parameter. For example, as shown in FIG. 19 and FIGS. 24A-24B, the default card 10 can have a background including a graphical representation corresponding to the volume of content or frequency of content generation in a secondary card collection 20 (e.g., the past or future collection) for a predetermined period of time. In a specific example, the default card 10 can have a background summarizing the parameter for each hour of the past 12 hours of user activity (e.g., smartwatch attention, notification volume, etc.). In a second example, the default card 10 can have a background including a graphical representation corresponding to the content of the first card or most prevalent content within the secondary card collection or the instantaneous card collection. In a specific example, when in the “future” stream, the watch face can render a graphical representation of the weather when the weather card is active; render a graphical representation of the traffic when the traffic card is active; render a graphical representation of a schedule when the schedule card is active; or render any other suitable graphical representation of any other suitable content of the stream. Alternatively, a graphical representation of the card content can be rendered in the foreground. Selection of the background (e.g., by the user) can set the summarized collection as active, open the set of content underlying the parameter, or perform any other suitable functionality.

However, the cards 10 can otherwise represent any other suitable node of a card organization hierarchy. The cards 10 within each collection can be organized temporally (e.g., in reverse chronological order, based on a time associated with each card 10, such as the time of receipt or the time of generation), in order of importance or relevance, by application, or be ordered in any other suitable manner.

Each card 10 is preferably operable between an active mode and an inactive mode, wherein each mode maps a different set of gestures with a different set of actions. A card 10 can be associated with a first set of actions in the active mode and a second set of actions in the inactive mode. The card 10 can additionally be associated with a first set of gestures in the active mode and be associated with a second set of gestures in the inactive mode. For example, an email card 10 can have reply, archive, and send to phone actions associated with a first, second, and third gesture when in the active mode, and have an open or read action associated with a fourth gesture in the inactive mode (e.g., wherein the first, second, and third gestures are associated with the card 10 that is currently active). An active card 12 can additionally initiate a set of functionalities on the primary or secondary device. For example, when the card 10 is a music control card 10, the song associated with the card 10 is preferably played through speakers on the primary or secondary device in response to card 10 selection or activation.

The card 10 centered within or occupying the majority of the display area is preferably the active card 12 and part of the active collection, while the remainder cards 10 of the set are preferably set as inactive. Selection of a card 10 can focus the display area on the card 10, shift the display area to a second virtual space (e.g., when the selected card 10 is a cover card 10), switch the card 10 between a first and second view, or perform any other suitable action on the card 10. Likewise, setting a collection as active preferably focuses the display area on one or more cards 10 of the collection, shift the virtual structure 30 such that the active collection is centered on the display area, or manipulate the collection in any other suitable manner. The system can additionally learn from the card 10 and/or collection selection and/or action parameters, and detect contextual patterns, interaction patterns, or extract any other suitable parameter from the card 10 and/or collection interactions.

In the active mode, the card 10 is preferably rendered such that the card 10 fully occupies the majority of the display area. The content of the card 10 is preferably rendered within the text area, but can alternatively be rendered at any other suitable portion of the display area. However, the active card 12 can alternatively be hidden. A single card 10 is preferably active at a time, but multiple cards 10 can alternatively be concurrently in the active mode. The active card 12 can be identified by the card indicator 16 that is missing, the background color of the active card 12, an icon, the displayed information on the active card 12, a combination of the above, or any other suitable indicator. In the inactive mode, the card 10 is preferably either not rendered on the display or rendered such that only the card indicator 16 (e.g., handle, portion of the card 10, etc.) is displayed.

The card indicators are preferably indicative of a second virtual card 10 adjacent to the card 10 centered and/or primarily displayed on the display area. The second virtual card 10 is preferably inactive, but can alternatively be active. The card indicator 16 is preferably a portion of the virtually adjacent card 10 that is rendered on the display area (e.g., wherein the adjacent card 10 preferably has the same dimensions as the first card 10 but can alternatively be larger or smaller), but can alternatively be a portion of the display area perimeter (e.g., delineated by a first color) or be any other suitable indicator. The card indicator 16 can additionally include a card identifier 16. The card identifier 16 is preferably an icon (e.g., a graphic), but can alternatively be a color, a pattern, a shape, a label, no identifier, or any other suitable identifier. The card identifier 16 is preferably selected by the application, but can alternatively be selected by the user, the manufacturer, randomly generated, or determined in any other suitable manner.

2. Receiving an Interaction on a Device Input.

Receiving an interaction on a device input S100 functions interact with the cards displayed on the display area. The interaction 200 can be received in association with a piece of content (e.g., card), with a collection of content, or in association with any other suitable virtual structure. The content or collection associated with the interaction is preferably the card that is instantaneously displayed on the display during interaction receipt, but can alternatively be any other suitable content or collection. Receiving the interaction can function to move the display area within the virtual space, but can alternatively move the virtual space relative to the display area. Alternatively, interaction received at the data input can move the cards from a first position within the virtual space to a second position within the virtual space. Alternatively, interaction can move the cards from a first virtual space to a second virtual space. Alternatively, interaction can interact with the information associated with the card. For example, the interaction can perform a functionality suggested by the card (e.g., order a taxi when the card queries “Order a Taxi?”). Alternatively, the interaction can be mapped to and execute an action to be performed on the card. For example, a predetermined functionality mapped to the content can be performed on the content in response to receipt of the interaction (e.g., delete an email, archive an email, respond to an email, etc.).

The user is preferably able to interact with both the active card and the inactive cards 14. A first set of interactions is preferably mapped to the interactive cards, and a second set of interactions is preferably mapped to the active card(s). However, user interaction can be limited to only the active card, to only the inactive cards, or limited in any other suitable manner. The interaction can be a vector interaction 220 (e.g., a gesture), a point interaction (e.g., a tap or selection), a macro interaction (e.g., device shaking), a touchless interaction (e.g., a hand wave over the display or a voice instruction), or be any other suitable interaction.

A set of interaction parameters can be extracted from each interaction. The interaction parameters can include an interaction timestamp (e.g., time of interaction initiation, time of interaction termination), interaction duration, position (e.g., start or origination position 222, end or termination position 223), magnitude (e.g., distance 221 or surface area covered), direction, vector angle relative to a reference axis, pattern (e.g., vector or travel pattern), vector projection on one or more coordinate axes, velocity, acceleration, jerk, association with a secondary interaction, or any other suitable parameter.

As shown in FIG. 4, vector interactions are preferably continuous, and extend from a start point (origination point, e.g., the initial point on the data input at which the gesture was received) to an end point (termination point, e.g., the last point on the data input at which the continuous gesture was received), wherein start and end points are connected by a substantially contiguous set of data input points. A vector interaction can include a displacement from a reference point, wherein the reference point can be an imaginary point on the display (e.g., the center point or the virtual threshold), be the start point, or be any other suitable reference point. For example, the displacement can be the length of the contiguous set of data input points or the difference between the start and end points. The vector interaction can include a direction, extending from the start point toward the end point. The vector interaction can be associated with an angle relative to the first axis of the display. The vector interaction can include a velocity, or the speed at which the interaction moved from the start point to the end point. The vector interaction can include an acceleration, pattern (e.g., differentiate between a substantially straight line and a boustrophedonic line), or any other suitable parameter.

The vector interactions can be classified, sorted, or otherwise classified into a set of vector descriptors. In one variation, the vector descriptors can include radially inward interactions 225 and radially outward interactions 226.

A radially inward interaction can be determined when the gesture (vector interaction) originates radially outward of the virtual threshold; when the gesture originates radially outward of the virtual threshold and terminates radially inward of the virtual threshold; when the vector interaction crosses the virtual threshold and the start point is radially outward of the virtual threshold; when the vector interaction crosses the virtual threshold and the end point is radially inward of the virtual threshold; when the start point is radially outward of the end point (e.g., the start point is more distal the center point than the end point); or when the gesture crosses an axis extending perpendicular the central axis; but can alternatively be determined in response to receipt of any other suitable set of interaction parameters.

A radially outward interaction can be determined when the gesture (vector interaction) originates radially inward of the virtual threshold; when the gesture originates radially inward of the virtual threshold and terminates radially outward of the virtual threshold; when the vector interaction crosses the virtual threshold and the start point is radially inward of the virtual threshold; when the vector interaction crosses the virtual threshold and the end point is radially outward of the virtual threshold; when the start point is radially inward of the end point (e.g., the start point is more distal the center point than the end point); or when the gesture remains within the space encircled by the virtual threshold (e.g., not crossing the virtual threshold); but can alternatively be determined in response to receipt of any other suitable set of interaction parameters.

Other types of interactions that can be received and quantified include selections (e.g., touch inputs below a threshold distance), audio inputs (e.g., receiving a spoken request), accelerometer interactions (e.g., wrist shaking, device shaking, device turning), proximity or ambient light interactions (e.g., waving a hand over the face of the watch), or any other suitable interaction.

3. Analyzing Interaction Parameters.

Analyzing the interaction parameters functions to extract the interaction parameters from the interaction, wherein the interaction parameters can subsequently be mapped to content and/or collection actions. As previously discussed, the interactions can be gestures (e.g., vector interactions), patterns (e.g., arcuate gestures, multi-touch gestures, etc.), selections (e.g., tap, select and hold, etc.), or be any other suitable interaction with the device. As discussed above, the parameters can include an interaction timestamp (e.g., time of interaction initiation, time of interaction termination), interaction duration, position (e.g., start or origination position, end or termination position), magnitude (e.g., distance or surface area covered), direction, vector angle relative to a reference axis, pattern (e.g., vector or travel pattern), vector projection on one or more coordinate axes, velocity, acceleration, jerk, association with a secondary interaction, or any other suitable parameter. The parameters can additionally or alternatively include the maximum parameter value, minimum parameter value, average parameter value, or any other suitable variable parameter value from the interaction. For example, the parameter can include the maximum speed, minimum speed, or time-averaged speed of the interaction. The interaction can be received at the touchscreen, a sensor (e.g., camera, accelerometer, proximity sensor, etc.), or received at any other suitable component. The interaction parameters are preferably analyzed by a processing unit of the smart watch, but can alternatively be analyzed by the secondary device (e.g., mobile phone), remote device, or any other suitable component. Analyzing the interaction parameters preferably includes extracting parameters from interaction and qualifying the interaction based on the parameter. Qualifying the interaction based on the parameter can include calculating a score based on the parameter value, categorizing the interaction based on the parameter value, sorting the interaction based on the parameter value, determining a categorization for the interaction based on a best-fit analysis of the interaction's parameter values, or qualifying the interaction in any other suitable manner.

In one specific example, the interaction can be categorized as one of an interaction set including a radially outward interaction, a radially inward interaction and a selection, based on the radially inward and outward definitions described above.

Alternatively or additionally, the interaction can be categorized as one of an interaction set including an interaction in a first direction and an interaction in a second direction opposing the first direction along a common axis. The interaction can be categorized as an interaction in the first or second direction based on a projection of the interaction vector onto the common axis.

Alternatively or additionally, the interaction can be categorized as one of an interaction set including an interaction in a third direction and an interaction in a fourth direction, wherein the fourth direction opposes and shares a second common axis with the third direction. The interaction can be categorized as an interaction in the third or fourth direction based on a projection of the interaction vector onto the second common axis. The second common axis can be perpendicular to the first common axis or be at any other suitable angle relative to the first common axis. Interactions along the second axis can map to the same actions as those in the first axis, or can be mapped to different actions.

Additionally or alternatively, the interaction can be categorized as one of an interaction set including a fast or slow interaction, wherein a fast interaction is an interaction having a velocity (e.g., maximum velocity, minimum velocity, average velocity, etc.) over a threshold velocity, and a slow interaction is an interaction having a velocity below a second threshold velocity. The first and second threshold velocities can be the same velocity value, or be different velocity values (e.g., wherein the first threshold velocity can be higher or lower than the second velocity value).

Additionally or alternatively, each interaction can have a set of interaction states, wherein each interaction state can be mapped to one of a progressive set of action states. The interaction state of an interaction can be determined based on the interaction duration, displacement, velocity, position, or based on any other suitable interaction parameter. For example, a vector interaction can have a first interaction state when the displacement from the start point exceeds a first displacement threshold, and a second interaction state when the displacement from the start point exceeds a second displacement threshold. The first interaction state can be associated with a first action, such as moving the card (on which the interaction is received) to an adjacent card collection, and the second interaction can be associated with a second action, such as performing an action associated with the card (e.g., opening the associated information on a secondary device, playing content associated with the information, sending a response associated with the information, etc.). However, the interaction parameters can be otherwise analyzed.

4. Mapping the Interaction to an Action and Action Application to the Content.

Identifying an action mapped to the interaction S300 functions to determine an action to be performed on the content of the card or on the collection. Applying the action to the information represented by the content S400 functions to act on the content. Examples of actions include facilitating navigation of the displayed area between cards organized in a virtual structure within a virtual space, facilitating the performance of an action on the content represented by the instantaneously displayed card, or otherwise acting on the content or virtual space. The action is preferably identified based on the content concurrently represented on the device display during interaction receipt and the parameters of the interaction, but can alternatively be determined based on virtual collections adjacent the active collection, the virtual structure of the collections, or determined in any other suitable manner. Each interaction is preferably mapped to a single action, wherein the interaction-action mapping is preferably determined by the information associated with the card and/or the operation mode of the card (e.g., whether the card is active or inactive), but can alternatively be determined based on the properties of the collection in which the card is located or determined in any other suitable manner.

Identifying the action can include categorizing the interaction as an interaction with the virtual structure or categorizing the gesture as an interaction with the content itself. Interaction categorization as an interaction with the virtual structure preferably controls traversal through the virtual structure, and sets various card collections as active. Interaction categorization as an interaction with the content preferably performs an action on the instantaneously displayed content and/or controls traversal between different pieces of content within the active collection. Alternatively, all interactions can interact only with the content. However, the interactions can be otherwise categorized and executed.

The interaction is preferably categorized based on the interaction parameters, but can alternatively be categorized in any other suitable manner. The gesture can be categorized based on its radial direction. Radially inward interactions are categorized as structure interactions, while radially outward interactions are categorized as content interactions, an example of which is shown in FIG. 18. However, the radial direction of the interaction can be otherwise mapped to different interaction. Alternatively, the radial direction of the interaction (e.g., radially inward or radially outward) is not mapped to a set of actions, wherein content or collection interaction is derived from the interaction direction along one or more axes. However, the gesture can be otherwise categorized. However, the gestures can be otherwise mapped to content and/or structure interactions.

The interaction can further be categorized based on its axial direction. For example, the axial direction of radially inward gestures can be mapped to different content actions. In particular, interactions in a first direction along a first axis perform a first action on the content, interactions in a second direction along the first axis perform a second action on the content, and interactions along a second axis interact with the active collection (e.g., scrolls through sequential content within the active collection). In another example, the axial direction of radially outward gestures can be mapped to collection interactions. In particular, radially outward gestures in the first direction along the first axis sets a second collection, arranged adjacent the previously active collection in the second direction along the first axis, as active, while radially outward gestures in the second direction along the first axis sets a third collection, arranged adjacent the previously active collection in the first direction along the first axis, as active. Radially outward gestures in a third or fourth direction along the second axis can interact with cards in the active collection (e.g., be treated as radially inward gestures in the fourth or third direction, respectively), or map to another action.

The interaction can be further categorized based on its velocity, wherein different interaction velocities can additionally or alternatively be mapped to different actions taken on the content. In one example, a gesture having a first velocity falling within a first velocity range opens a list of possible actions 310 that can be performed on the content and/or content within the collection, while a second gesture that has a second velocity falling within a second velocity range automatically performs a stored action 300 on the content. The first velocity range and second velocity range can be separate and distinct (e.g., separated by a threshold velocity and/or a third velocity range), overlap, or be related in any other suitable manner.

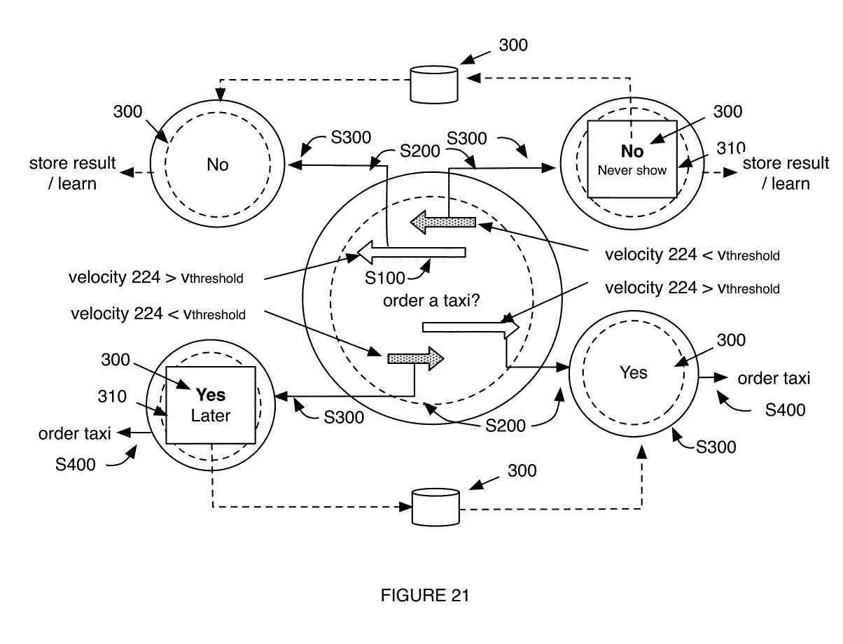

In a specific example, the device displays a first list of options (e.g., a list of positive actions that can be taken on the content) in response to receipt of a gesture in the first direction having a velocity below the velocity threshold, and performs an action selected from the first list on the content; automatically performs a stored action (e.g., previously selected action for a secondary piece of related content or otherwise automatically determined action from the first list of options, an example of which is shown in FIG. 21) on the content in response to receipt of a second gesture in the first direction having a velocity above the velocity threshold; displays the same or a different list of options in response to receipt of a third gesture in the second direction having a velocity below the velocity threshold, and performs an action selected from the second list on the content; and automatically performs a stored action (e.g., previously selected or otherwise automatically determined action from the second list of options) on the content in response to receipt of a fourth gesture in the second direction having a velocity above the velocity threshold. The stored action can be an action previously selected for the collection, an action previously selected for a related piece of content (e.g., content generated from the same application, content received from the same source, etc.), be a predefined action, or be any other suitable stored action. The list of action options can be specific to the content, specific to the content collection, generic, or be any other suitable list of options. In one example, the first list of actions can include a positive response, such as querying whether the user desires the positive action associated with the first direction, crafting a response, sending an automatic response, accepting the action recommended by the content, or any other suitable positive action. In a second example, the second list of actions can include a negative response, such as querying whether the user desires the negative action associated with the second direction, deleting the content, sending an automatic rejection, rejecting the action recommended by the content, or any other suitable negative action.

The interaction can be further categorized based on the distance of the interaction. In one variation, a first gesture distance above a distance threshold maps to a first action, while a second distance below the distance threshold maps to a second action. In a second variation, a first gesture distance above a distance threshold maps to an action, while a second distance below the distance threshold does not trigger an action. However, the gesture distance can be otherwise mapped. In a third variation, gestures having distances below a threshold distance can be categorized as selections.

The interaction can be further categorized based on the pattern of the interaction parameters. In one example, the gesture is mapped to a first action in response to determination of a first velocity pattern, and mapped to a second action in response to determination of a second velocity pattern. In a second example, the gesture is mapped to a first action in response to determination of a first gesture path shape, and mapped to a second action in response to determination of a second gesture path shape.

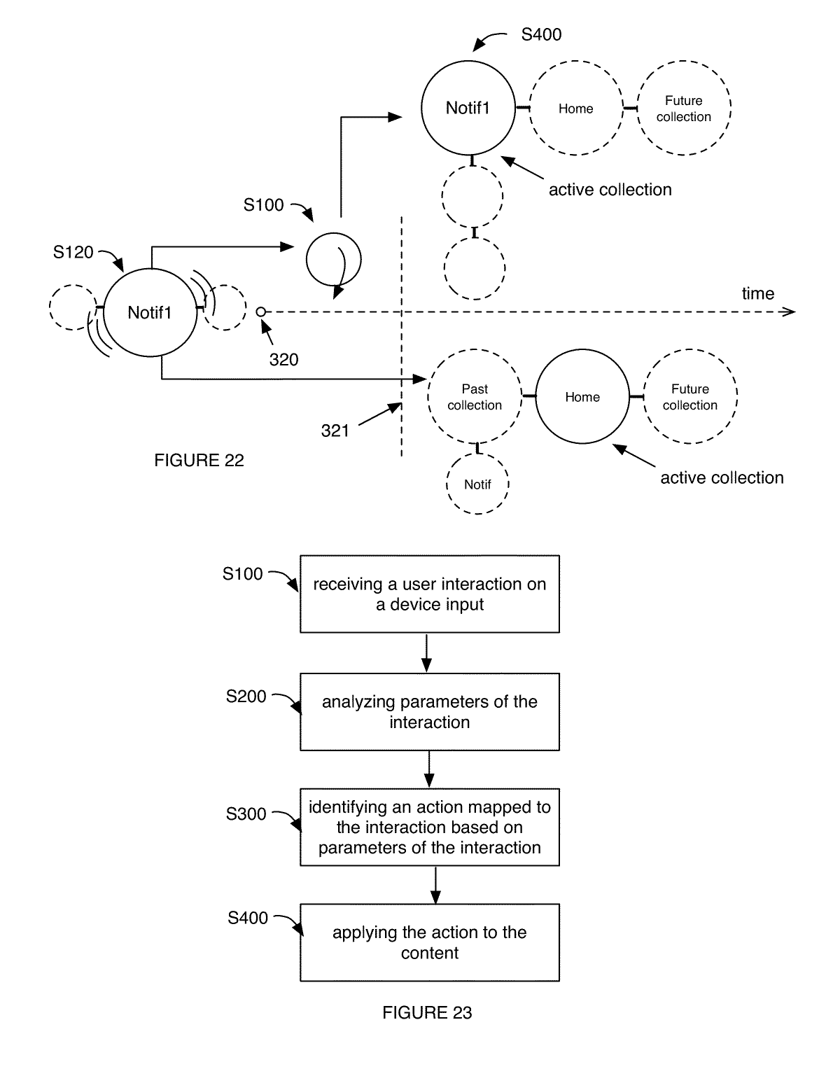

The interaction can be further categorized temporally. In one variation, the interaction can be categorized based on its temporal proximity to a reference time 320. The interaction time can be the time of initial interaction receipt, the time of interaction termination, an intermediate time, or any other suitable time. The reference time can be the occurrence time of an event, such as a notification time (an example of which is shown in FIG. 22), or any other suitable event. The notification can be a physical, visual, audio, or any other suitable notification indicative of the content. The notification is preferably generated by the device, but can be otherwise controlled. The notification can be generated in response to receipt of the content, by the content, or generated in any other suitable manner. For example, the device can control (e.g., operate) a notification component to generate the notification S120. The notification component can be a vibratory motor, the display (e.g., wherein the device temporarily displays a notification for the content), a speaker, or any other suitable notification component. In this variation, the interaction can be a signal indicative of user attention to the display. The signal indicative of user attention to the display can be measured at a sensor, the device input, or at any other suitable input. For example, the smartwatch accelerometer can be monitored for a signal indicative of motion along a vector perpendicular the virtual axis (e.g., beyond a threshold distance or angle), indicative of device rotation with the wrist toward the user. In a second example, the front-facing camera can be monitored for a signal indicative of facial proximity to the watch face (e.g., detecting the user's face in the field of view, changes in ambient light coupled with accelerometer measurements, etc.). In a third example, the microphone can be monitored for sound patterns indicative of user interest. However, any other suitable signal can be monitored. In this variation, the content stream associated with the content for which the notification was generated can be set as the active content stream in response to detection of the signal indicative of user attention to the display within a predetermined time period 321 from the reference time, wherein a graphical representation of the content can be displayed in response to setting the content stream associated with the content as the active content stream. The default or home content stream can be retained as the active content stream in response to an absence of the signal indicative of user attention to the display within the predetermined time duration from the reference time.

The content that is acted upon is preferably determined based on the received interaction. A first set of interactions is preferably associated with active cards, and a second set of interactions is preferably associated with inactive cards. Radially inward vector interactions are preferably associated with inactive cards and/or collection interaction, and the remainder of interactions can be associated with active cards. However, a subset of the remainder of interactions (e.g., touchless control, multiple point touch, etc.) can be reserved for overall device control, such as turning the device off. For example, radially outward vector interactions, a first pattern of macro interactions, and single point interactions can be associated with active cards, while multiple point interactions (e.g., covering the display) and touchless gestures (e.g., waving a hand over the display) are reserved for switching the device into a standby mode or switching the display off. However, any other suitable first, second, and/or third set of interactions can be associated with the inactive cards, active cards, and device control, respectively.

a. Examples of Interaction Mapping.

In a first variation of the virtual structure, the cards are arranged in one or more arrays. Cards in the same hierarchy are preferably arranged in the same array, but can alternatively be arranged in different arrays. The array can have a first dimension extending along a first axis, but can alternatively have two or more dimensions extending along two or more axes. In response to receipt of a gesture in a first direction within a predetermined angular range of a first axis, the display area is preferably moved in a second direction opposing the first direction along the first axis. Alternatively, in response to receipt of the gesture in a first direction within a predetermined angular range of a first axis, a second card adjacent the first card in a second direction opposing the first direction along the first axis is displayed within the display area and set as the active card. For example, a gesture toward the right moves the card to the left of the instantaneous card toward the right, to take the place of the instantaneous card.

In a second variation of the virtual structure, as shown in FIG. 7, in response to receipt of a radially inward gesture in the second direction, the display area is preferably moved to focus on the cards in the second collection, or, conversely, the second stack is pulled into the field of view of the display area. In response to receipt of a radially inward gesture in the first direction, the display area is preferably moved to focus on the cards in the third stack, or, conversely, the third stack is pulled into the field of view of the display area. The previously inactive card in the second or third stack is preferably animated to slide into the display from the portion of the display previously rendering the card portion in substantially the same direction as the vector interaction with substantially the same velocity as the vector interaction. The previously inactive card preferably has substantially the same dimensions as the active card or the display, but can alternatively have different dimensions. However, the inactive card can be animated to unfold, expand to fill the display area, or be otherwise animated.

The display of a secondary device, such as a smartphone or tablet, can additionally be represented in the virtual structure. In response to movement of the card into the virtual position representative of the secondary device, the information associated with the card is preferably presented (e.g., rendered, displayed, played, etc.) on the secondary device. However, the virtual structure can otherwise include the secondary device.

In a third variation of the virtual structure, the cards are arranged in collections, wherein each collection is preferably independently arranged within the virtual structure. The collection can be identified by a cover card, or can be otherwise identified. A portion of each card of the collection is preferably displayed in response to activation of the cover card (e.g., by receipt of a radially inward gesture crossing through the data input area mapped to the cover card). A portion (e.g., segment) of each card of the collection (or subset of the collection) can be arranged radially about an active center card, or can be arranged radially about a background (e.g., wherein no card of the collection is active). The collection preferably has a limited number of cards (e.g., 4, 6, 7, etc.), but can alternatively have an unlimited number of cards.

In a fourth variation of the virtual structure, the cards are arranged in a stack representative of a card collection, wherein the stack is preferably arranged normal to the third axis of the display area. The virtual structure can include a set of stacks, wherein adjacent stacks preferable overlap but can alternatively be disparate. The stacks can be arranged in an array (e.g., a matrix), a hexagonal close-packed arrangement, or in any other suitable configuration. Gestures can move cards between adjacent collections or stacks, or can move the display area relative to the collections or stacks. Cards can be moved from the top, bottom, middle, or any other suitable portion of the stack to the top, bottom, middle, or any other suitable portion of a different stack. As shown in FIG. 6, in response to receipt of a radially outward gesture in a first direction on an active card in a first collection, the active card is virtually transferred into a second stack adjacent the first stack in the first direction. In response to receipt of a second radially outward gesture in a second direction on a card in the first stack, the active card is preferably virtually transferred into a third stack adjacent the first stack in the second direction.

In a fifth variation of the virtual structure, the cards are arranged in a similar structure as that of the fourth variation. However, the cards cannot be moved from stack to stack, but are instead acted upon and discarded, or simply discarded, in response to a secondary interaction. In this variation, a first action associated with the active card or collection (e.g., positive action, such as executing the recommended action, replying to the content, etc.) is performed on the content represented by the active card in response to receipt of a radially outward gesture in a first direction on an active card in a first collection. A second action associated with the active card or collection (e.g., a negative action, such as deleting or archiving the recommended action) is performed on the content represented by the active card in response to receipt of a second radially outward gesture in the second direction opposing the first on an active card in the first collection. The device can additionally or alternatively sequentially scroll through the cards within the stack in response to receipt of a third or fourth radially outward gesture along a second axis different from that of the first and second direction (first axis). The second axis is preferably perpendicular to the first axis, but can alternatively be arranged in any other suitable relative arrangement. The device can additionally or alternatively perform a third set of actions in response to receipt of a radially outward or radially inward gesture along a third axis at an angle between the first and second axis, wherein the third set of actions can overlap with or be entirely different from the first and second sets of actions.

The active card can be animated to slide out of the display area in substantially the same direction and with substantially the same velocity as the vector interaction, wherein a second card of the collection (preferably having the same dimensions as the first card, but alternatively different dimensions) slides into the display area in substantially the same direction and with substantially the same velocity as the vector interaction, expands to fill the display area, or is otherwise animated and rendered on the display area.

The card sub-collection can be sequentially traversed through in response to receipt of a radially outward gesture in a first direction (e.g., in a vertical or horizontal direction) on an active card. Portions of the cards of the sub-collection adjacent the active card are preferably concurrently displayed with the active card, but can alternatively be not displayed. For example, the inactive card adjacent the active card in a second direction opposing the first direction can be shown in response to receipt of the radially outward gesture in the first direction, wherein the previously inactive card can be set as active and the previously inactive card can be set as inactive. Alternatively, a first action can be performed on the piece of information associated with the active card in response to receipt of a radially outward gesture in a first direction on the active card and a second action can be performed on the piece of information associated with the active card in response to receipt of a radially outward gesture in a second direction opposing the first direction on the active card. For example, the active card can be associated with a notification requesting a response (e.g., a “yes” or “no” answer), wherein a radially outward gesture to the left can reply “yes” to the notification and a radially outward gesture to the right can reply “no” to the notification. Alternatively, the active card can be set as inactive in response to receipt of the radially outward gesture in the first direction, wherein the gesture includes a vector directed toward a closing indicator, a card indicator 16, or the position at which the active card was located prior to activation. A portion of the card can be displayed in response to transition from an active to inactive mode. Alternatively, the card can be switched from the active mode to an inactive mode in response to receipt of a radially inward gesture in any direction, in response to receipt of a radially inward gesture in a specific direction (e.g., the first direction), or in response to receipt of any other suitable data input.

b. Actions Available to Active and Inactive Cards.

Alternatively, the card that is acted upon can be the card that is rendered at the display area point that is mapped to the data input point at which the interaction was received. For example, if the interaction (e.g., start point or tap) is received or begins at a portion of the display rendering an active card 12, the action associated with the active card 12 for the interaction would be performed on the active card 12. If the interaction is received or begins at a portion of the display rendering an inactive card 14, the action associated with the inactive card 14 for the interaction would be performed on the active card 12.

Actions that can be taken on inactive card 14s are preferably limited to opening the inactive card 14 (e.g., setting the inactive card 14 as the active card 12). Alternatively, actions on the inactive card 14 can be limited to moving the display area within the virtual card space to focus on the inactive card 14 or collection represented by the inactive card 14. Alternatively, any other suitable action can be taken on the card. The inactive card 14 is preferably set as the active card 12 in response to receipt of a radially inward gesture passing through a portion of the display or a portion of the virtual threshold that is mapped to the inactive card 14. The inactive card 14 is preferably rendered in a centralized position on the display area in response to switching to the active mode.

Actions that can be taken on active card its are preferably determined based on the information associated with the active card 12. The actions can be defined by the information associated with the active card 12 (e.g., wherein the information associates gestures with actions), determined based on the type of information associated with the active card 12, determined based on the application that generated the information associated with the active card 12, or determined in any other suitable manner. For example, when the card information is a message or generated from a messaging application (e.g., an email, text, or online messaging system), the actions associated with the card can include moving the card to a “read” collection or replying to the message (e.g., opening a text, voice, or video recording program). In another example, when the card is representative of a home device controller, the actions associated with the card can include sending a first instruction to turn the home device on and sending a second instruction to turn the home device off. In another example, when the card is a cover card, the actions associated with the card can include scrolling through the collection of cards represented by the cover card.

Each active card 12 or collection is preferably associated with a first, second, third, and fourth action, but can alternatively be associated with any suitable number of actions. The first action is preferably associated with a vector interaction in a first direction (e.g., a swipe to the right), the second action is preferably associated with a vector interaction in a second direction opposing the first direction (e.g., a swipe to the left), and the third action is preferably associated with a point interaction (e.g., a selection, tap, or double tap on the active card 12), and the fourth action is preferably associated with a macro interaction (e.g., device vibration above a predetermined threshold, device rotation about a longitudinal axis, etc.). The first action can be a positive action that generates and/or sends instructions to open a second program, can move the card into a collection adjacent the instantaneous collection in the first direction within the virtual structure, or can move the displayed area of the virtual structure. Examples of positive actions include opening the information on a secondary device, generating instructions to open or run a secondary program (e.g., to reply to a message), and sending a positive response to a request. Positive actions can additionally or alternatively include actions requiring further user input (e.g., replying to content, such as an email, posting content to a social networking system, etc.), actions associated with a positive response to the content (e.g., accepting an action recommended by the content, recategorizing the content into an actionable content stream), or include any other suitable positive action.

The second action can be a negative action that generates and/or sends instructions to close a program or ignore the card, can move the card into a collection adjacent the instantaneous collection in the second direction within the virtual structure, or can move the displayed area of the virtual structure. Examples of negative actions include removing a notification from a stack of new notifications and sending a negative response to a request, a specific example of which is shown in FIG. 12. Negative actions can additionally or alternatively include actions reducing or eliminating further user input (e.g., deleting the content, archiving the content, removing the content from the collection, the smartwatch, or a secondary device, etc.), actions associated with a negative response to the content (e.g., rejecting an action recommended by the content, recategorizing the content into an non-actionable content stream), or include any other suitable negative action.

The third action can be an informational action. Examples of informational actions can include switching the display mode of the card between the summary view and the detailed view. The card can be animated to expand from a subset of the display in the summary view to substantially fill the entirety of the display in the detailed view, to rotate from a first side representative of the summary view about the second axis to display a second side representative of the detailed view, or be animated in any other suitable manner. The third action can alternatively be a selection action that displays the card collection represented by the selected card. The fourth action can be a retraction action, wherein the action performed on the card can be undone or retracted. However, the first, second, third, and fourth actions can be any other suitable action.

In one example, selection of an active card 12 (e.g., by receipt of a tap) can open a detailed view of the content represented by the active card 12. For example, the active card 12 can include a summary of the content, while card selection can display the full content underlying the summary. In a specific example, the active card 12 can include an email title, sender name, a sample image, or any other suitable snippet of the underlying content, while card selection can display the full email or message. However, card selection can be mapped in any other suitable manner.

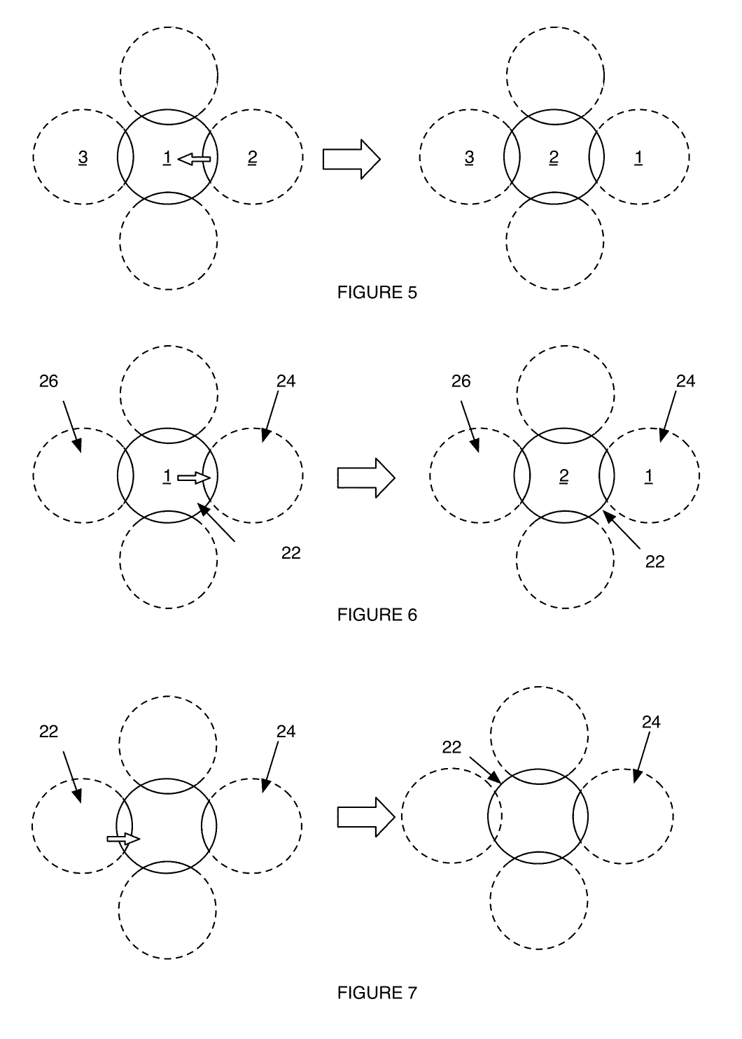

In another example, selection of an inactive card 14 (e.g., by receipt of a radially inward gesture passing through the data input area mapped to the inactive card 14) preferably moves the inactive card 14 radially inward toward the center of the display. The portion of the display previously occupied by the previously inactive, now active card 12 can be replaced by a portion of the displaced card, be replaced by a portion of another card of the set, or remain a portion of the previously inactive card 14 (e.g., wherein the portion of the display indicates the identity of the active card 12). The active card 12 can displace the other, inactive card 14s of the collection, such that the active card 12 occupies the majority or entirety of the display area, or the other inactive card 14s of the collection can be concurrently displayed with the active card 12 (e.g., wherein segments of the inactive card 14s can be displayed along the perimeter of the display area). Alternatively, when the card is part of an unlimited or large collection (e.g., having more than the number of indicators that can fit on the display perimeter), a portion of a previously undisplayed card is preferably displayed, either at the space vacated by the previously inactive card 14 or at another point of the perimeter, wherein the positions of each of the previously displayed inactive card 14s can be rearranged, as shown in FIG. 5. Each card of the collection can be a cover card, wherein a second sub-collection of cards can be accessed when the cover card is active. For example, the collection of cards can include a “read” sub-collection, “unread” sub-collection, and “replied” sub-collection, wherein selection of the cover card of the “read” sub-collection permits access to the sub-collection of read messages (e.g., wherein each card of the sub-collection is associated with a message), selection of the cover card of the “unread” sub-collection permits access to the sub-collection of unread messages, and selection of the cover card of the “replied” sub-collection permits access to the sub-collection of reply messages. The sub-collection can be arranged in a list, array, or any other suitable virtual structure. Alternatively, the cards can be content cards or any other suitable cards.

c. Context-Based Content Display Selection.

The method can additionally include selecting the cards to display. More preferably, the method includes selecting the inactive cards to display. The inactive cards to display can be selected by the user (e.g., on a secondary device), predetermined, automatically selected by the device or a secondary device, selected based on the virtual structure of the active card, determined based on the information or type of information associated with the active card, or selected in any other suitable manner. The number of inactive cards shown is preferably limited, and can be determined by the user (e.g., on a secondary device), predetermined, automatically selected by the device or a secondary device, selected based on the virtual structure of the active card, determined based on the information or type of information associated with the active card, or selected in any other suitable manner. Alternatively, an unlimited number of inactive cards can be displayed.

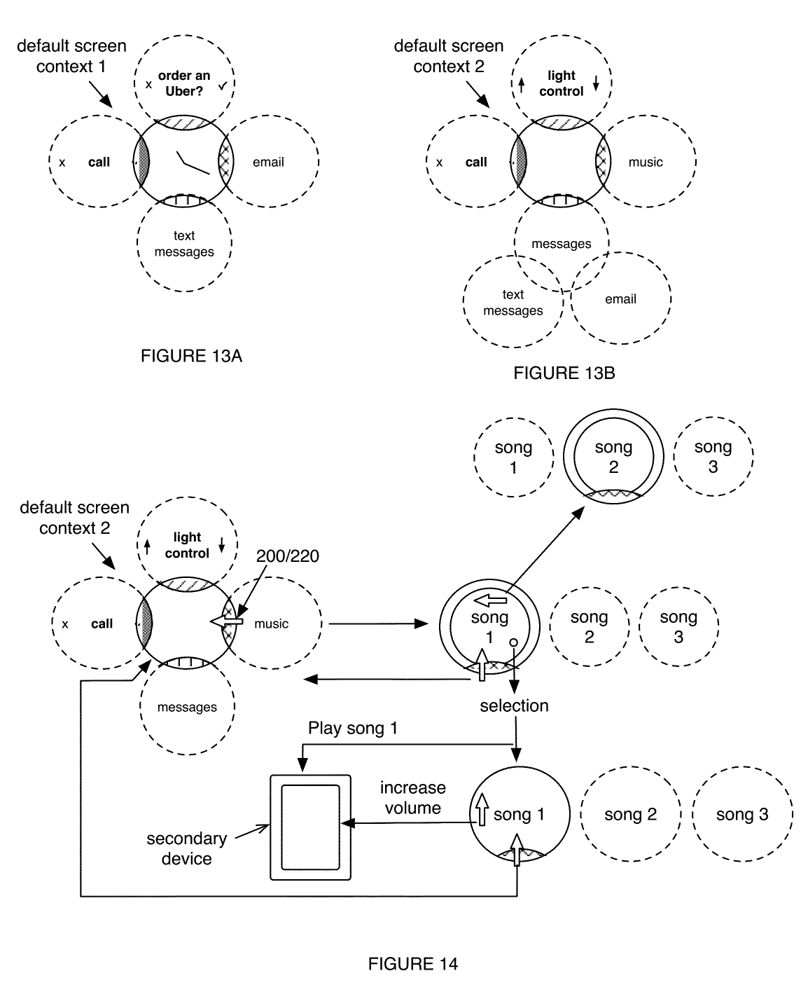

In one variation, the set of displayed inactive cards is automatically determined based on the instantaneous context, wherein a first set of inactive cards can be displayed in a first context, and a second set of inactive cards can be displayed in a second context. The context can be determined based on the instantaneous time, location, scheduled events determined from a calendar associated with the device (e.g., through the secondary device), the ambient noise, the changes in device position (e.g., the acceleration patterns of the device), the frequency of notifications received, ambient light parameters (e.g., spectrum, intensity, etc.), or determined in any other suitable manner. For example, a first context can be determined when a first unique intersection of time and location is detected and a second context can be determined when a second unique intersection of time and location is detected, specific examples of which are shown in FIGS. 13A and 13B, respectfully. The inactive cards are preferably cover cards associated with a collection of secondary cards (e.g., application cards, information cards, etc.), but can alternatively be application cards, information cards, a combination thereof, or any other suitable card of any other suitable hierarchy. Card selection can additionally include selecting the display parameters for the card. Display parameters include the card color (e.g., background color), card size, card shadow or highlight, card indicator, or any other suitable display parameter. Cards having higher priority, as determined from frequency of use, frequency of activity (e.g., frequency of notifications received), age of activity, determined by the user, predetermined, or otherwise determined, can have a larger portion of the card displayed relative to the remainder of inactive cards, be highlighted, be animated, or emphasized in any other suitable manner.

For example, when the instantaneous location of the device or secondary device corresponds with a work-associated location and/or the ambient light corresponds with a work-associated light spectrum (e.g., incandescent light instead of UV), a work context can be determined and the inactive cards selected for display can include a music cover card (wherein activation would permit selection of a song card and subsequent play of music associated with the song card), a message cover card (wherein activation would permit access to email and other text messages), a food delivery service card (wherein activation would facilitate selection, purchase, and delivery of a food item), and a calendar cover card (wherein activation would permit access to an array of calendar events). In a second example, when the instantaneous location of the device or secondary device corresponds with a work-associated location and the instantaneous time corresponds with a meeting scheduled on the calendar associated with the device, a meeting context can be determined and the inactive cards selected for display can be a phone call card (wherein activation would facilitate the initiation of a phone call), an email card (wherein activation would permit access to an array of email messages associated with a first user account), a text message card (wherein activation would permit access to messages associated with a second user account), a record card (wherein activation would initiate a program to record ambient audio), and a mute card (wherein activation would suppress or store without notification all incoming data below a priority threshold). In a third example, when the instantaneous location of the device or secondary device is changing beyond a velocity threshold, a travelling context can be determined, and the inactive cards selected for display can be a direction card (wherein activation would result in display of directions to an estimated or received destination), a phone call card, and a message cover card. Alternatively, the active cards selected for display can be a set of direction cards, wherein each card is associated with a deviation from travel along the previous road. Each card can additionally initiate functionalities of the portable device, such as sending instructions to the portable device to vibrate in response to a direction card instructing the user to turn right, and vibrate twice in response to a direction card instructing the user to turn left. In a fourth example, when the device position sensor detects a change in position or detects a predetermined position change frequency (e.g., walking, biking, motorcycling, etc.), an exercising context can be determined, and the inactive cards selected for display can include a physical metric card (e.g., steps taken, heart rate, travel velocity, etc.). However, the cards can be otherwise operable or selected based on the user context.

The method can additionally include displaying notifications. The notifications are preferably received from the secondary device, but can alternatively be generated by the primary device. The notifications are preferably prioritized based on the associated urgency (e.g., wherein more urgent notifications are given higher priority), whether the notification was generated based on the determined instantaneous context (e.g., wherein notifications generated based on the context are given higher priority), the application that generated the notification, the rate at which notifications are received from the application, or based on any other suitable parameter. Alternatively, the notifications can be prioritized based on historical user actions (e.g., wherein more frequently accessed notifications have higher priority), based on user preferences, or otherwise prioritized. For example, context-based notifications, text messages, and received calls can have a first priority, emails can have a second priority, and any other notifications can have a third priority. Notifications can be displayed in different modes based on the associated priority. For example, in response to the notification priority exceeding a first threshold, the notification can be rendered on the display and a light, vibration, or any other suitable secondary mechanism used. In response to the notification priority falling between the first threshold and a second threshold, the notification can be rendered on the display. In response to the notification priority falling between the second threshold and a third threshold, the notification can be indicated by highlighting the cover card representing the collection in which the card representing notification is located. In response to the notification priority falling between the third threshold and a fourth threshold, a card representing the notification can be included in a collection, but no special indication of the notification rendered. However, the receipt of the notification can be indicated in any other suitable manner. A notification card is preferably generated in response to notification card receipt at the device. The notification card is preferably included in a collection of cards associated with the application that generated the notification, but can alternatively be included in a collection of notification cards, wherein the collection of notification cards can be viewed as a list or filtered by genre, application, or any other suitable parameter. The notifications can additionally facilitate user preference refinement, more preferably context-based user preference refinement. The system or a remote system can subsequently learn from the user responses to the notifications (e.g., through machine learning methods). For example, a first notification querying whether the user will be driving or taking public transportation home can be displayed in response to the time of day coinciding with a travelling time, wherein the user response to the notification can be stored for subsequent direction determination the next time the time of day coincides with a travelling time.

The method can additionally include changing the card renderings in response to a global parameter change. The look (e.g., color, shape, font, etc.) and/or animation of all cards are preferably controlled by a set of global parameters, wherein a change in the global parameter value preferably results in a change across all virtual cards displayed on the device. However, subsets of virtual cards can be individually controlled by different sets of rendering parameters, or be controlled in any other suitable manner.

5. Examples.

In a first embodiment of the method, as shown in FIG. 9, a segment of a notification cover card and a segment of a navigation cover card are rendered on the default screen. The default card can be blank, can be a watch face, an image, video, or any other suitable visual content. The notification cover card is preferably activated in response to receipt of a first gesture. The first gesture is preferably a radially inward gesture crossing the virtual threshold along a portion of the virtual threshold mapped to the notification cover card. However, the first gesture can be any other suitable gesture. In response to activation of the notification cover card, individual notification cards are serially displayed in response to receipt a second gesture. Each newly displayed card is preferably switched from an inactive mode to an active mode, and each card that is displaced from the display area is preferably switched from an active mode to an inactive mode. Switching the card operation mode from an active mode to an inactive mode preferably additionally performs an action on the card, such as marking the card as “viewed,” but can alternatively leave the card unchanged. The second gesture is preferably a radially outward gesture within a predetermined angular range of a first axis (e.g., horizontally), wherein the individual notification cards are preferably aligned along the first axis, but can alternatively be a radially outward gesture within a predetermined angular range of a second axis (e.g., vertically), wherein the individual notification cards are preferably aligned along the second axis. The remaining axis (e.g., second axis and first axis, respectfully) preferably corresponds to one or more actions. For example, a first action is preferably performed in response to receipt of a third gesture in a first direction within a predetermined range of the remaining axis, a second action can be performed in response to receipt of a fourth gesture in a second direction within a predetermined range of the remaining axis, and a third action (e.g., switching from a summary view to a detailed view) can be performed in response to receipt of a point interaction (e.g., tap, double tap, hold, etc.). Each notification card is preferably associated with a different set of actions, based on the type of notification. For example, for an email message (e.g., email notification), the email message is displayed in the text area 123, a radially outward gesture in a first direction opens a reply program to reply to the email, and a radially outward gesture in a second direction sorts the email into a trash collection (wherein a cover card representing the trash collection is preferably rendered concurrently with the email message in the second direction), and a radially outward gesture in a third direction simultaneously marks the email message as read and pulls a second email message into the display. A radially inward gesture in the first direction that crosses the portion of the virtual threshold associated with the trash collection preferably activates the trash collection, wherein message cards within the trash collection can be serially viewed.

The navigation cover card is preferably activated in response to receipt of a fifth gesture. The fifth gesture is preferably a radially inward gesture crossing the virtual threshold along a portion of the virtual threshold mapped to the navigation cover card. However, the fifth gesture can be any other suitable gesture. In response to activation of the navigation cover card, individual group cover cards (e.g., representative of groups of applications) or application cover cards (e.g., representative of an application, such as Twitter, another social networking system, a telephone application, etc.) are displayed. The cover cards can be serially displayed in response to receipt of a sixth gesture, can be concurrently displayed about the perimeter of the display, or can be displayed in any other suitable manner. The cover cards can be activated or opened in response to receipt of a seventh interaction, wherein cover card activation preferably displays one or more cards of the collection associated with the respective cover card. The remaining group or application cover cards are preferably simultaneously displayed with the cards of the active collection, but can alternatively be hidden or replaced. The seventh interaction can be a point interaction (e.g., a tap or double tap) on the portion of the display rendering the cover card or a radially inward gesture through a portion of the display or virtual threshold corresponding to the cover card. The collection of cards associated with the group or application cover cards can include cover cards or information cards. The information cards preferably enable similar actions as the notification cards, and can include notification cards. The cover cards preferably enable similar actions as the group or application cover cards, and can include sub-group or application cover cards. The active card identity is preferably identified by the rendered content of the card, but can alternatively be identified by an icon, a color (e.g., a background color), or any other suitable card indicator.

A portion of a card representative of the default screen (default screen indicator) is preferably concurrently rendered with every active card, wherein the default screen is preferably rendered in response to receipt of a radially inward gesture crossing through the portion of the display or virtual threshold mapped to the default screen indicator, but can alternatively be rendered in response to receipt of any other suitable interaction. The default screen indicator is preferably rendered as aligned with the second axis along the bottom of the display, but can alternatively be rendered in any other suitable orientation.

In a second embodiment of the method, a segment of a notification cover card and a segment of a filter cover card are rendered on the default screen. The default card can be blank, can be a watch face, an image, video, or any other suitable visual content. Notifications received from a secondary device are preferably included in the collection of notification cards associated with the notification cover card. The notification cover card is preferably activated in response to receipt of a first gesture. The first gesture is preferably a radially inward gesture crossing the virtual threshold along a portion of the virtual threshold mapped to the notification cover card. However, the first gesture can be any other suitable gesture. In response to activation of the notification cover card, individual notification cards are serially displayed in response to receipt a second gesture. Each newly displayed card is preferably switched from an inactive mode to an active mode, and each card that is displaced from the display area is preferably switched from an active mode to an inactive mode. Switching the card operation mode from an active mode to an inactive mode preferably additionally performs an action on the card, such as marking the card as “viewed,” but can alternatively leave the card unchanged. The second gesture is preferably a radially outward gesture within a predetermined angular range of a first axis (e.g., horizontally), wherein the individual notification cards are preferably aligned along the first axis, but can alternatively be a radially outward gesture within a predetermined angular range of a second axis (e.g., vertically), wherein the individual notification cards are preferably aligned along the second axis. The remaining axis (e.g., second axis and first axis, respectfully) preferably corresponds to one or more actions. For example, a first action is preferably performed in response to receipt of a third gesture in a first direction within a predetermined range of the remaining axis, a second action can be performed in response to receipt of a fourth gesture in a second direction within a predetermined range of the remaining axis, and a third action (e.g., switching from a summary view to a detailed view) can be performed in response to receipt of a point interaction (e.g., tap, double tap, hold, etc.). Each notification card is preferably associated with a different set of actions, based on the type of notification. For example, for an email message (e.g., email notification), the email message is displayed in the text area, a radially outward gesture in a first direction opens a reply program to reply to the email, and a radially outward gesture in a second direction sorts the email into a trash collection (wherein a cover card representing the trash collection is preferably rendered concurrently with the email message in the second direction), and a radially outward gesture in a third direction simultaneously marks the email message as read and pulls a second email message into the display. A radially inward gesture in the first direction that crosses the portion of the virtual threshold associated with the trash collection preferably activates the trash collection, wherein message cards within the trash collection can be serially viewed.

The filter cover card preferably applies a parameter filter, such as a content filter, a genre filter, an application filter, or any other suitable filter to the array of notification cards. For example, applying a Facebook filter to the notification cards would filter out all but the notifications generated by a Facebook application. In another example, applying an SMS filter to the notification cards would filter out all but the notifications generated by an SMS messaging service. In another example, applying a messages filter to the notification cards would filter out all but the notifications received from a second user. The filter cover card is preferably activated in response to receipt of a fifth gesture. The fifth gesture is preferably a radially inward gesture crossing the virtual threshold along a portion of the virtual threshold mapped to the navigation cover card. However, the fifth gesture can be any other suitable gesture. In response to activation of the filter cover card, individual filter cards (e.g., representative of a filtering vector) are displayed. The cover cards can be serially displayed in response to receipt of a sixth gesture, can be concurrently displayed about the perimeter of the display, or can be displayed in any other suitable manner. The cover cards can be activated or opened in response to receipt of a seventh interaction, wherein cover card activation preferably displays one or more cards of the collection associated with the respective cover card. The remaining group or application cover cards are preferably simultaneously displayed with the cards of the active collection, but can alternatively be hidden or replaced. The seventh interaction can be a point interaction (e.g., a tap or double tap) on the portion of the display rendering the cover card or a radially inward gesture crossing through a portion of the display or virtual threshold corresponding to the cover card. The collection of cards associated with the filter cards preferably include the notification cards, but can alternatively be sub-collection cover cards or any other suitable cards. The active card identity is preferably identified by the rendered content of the card, but can alternatively be identified by an icon, a color (e.g., a background color), or any other suitable card indicator.

A portion of a card representative of the default screen (default screen indicator) is preferably concurrently rendered with every active card, wherein the default screen is preferably rendered in response to receipt of a radially inward gesture crossing through the portion of the display or virtual threshold mapped to the default screen indicator, but can alternatively be rendered in response to receipt of any other suitable interaction. The default screen indicator is preferably rendered as aligned with the second axis along the bottom of the display, but can alternatively be rendered in any other suitable orientation.

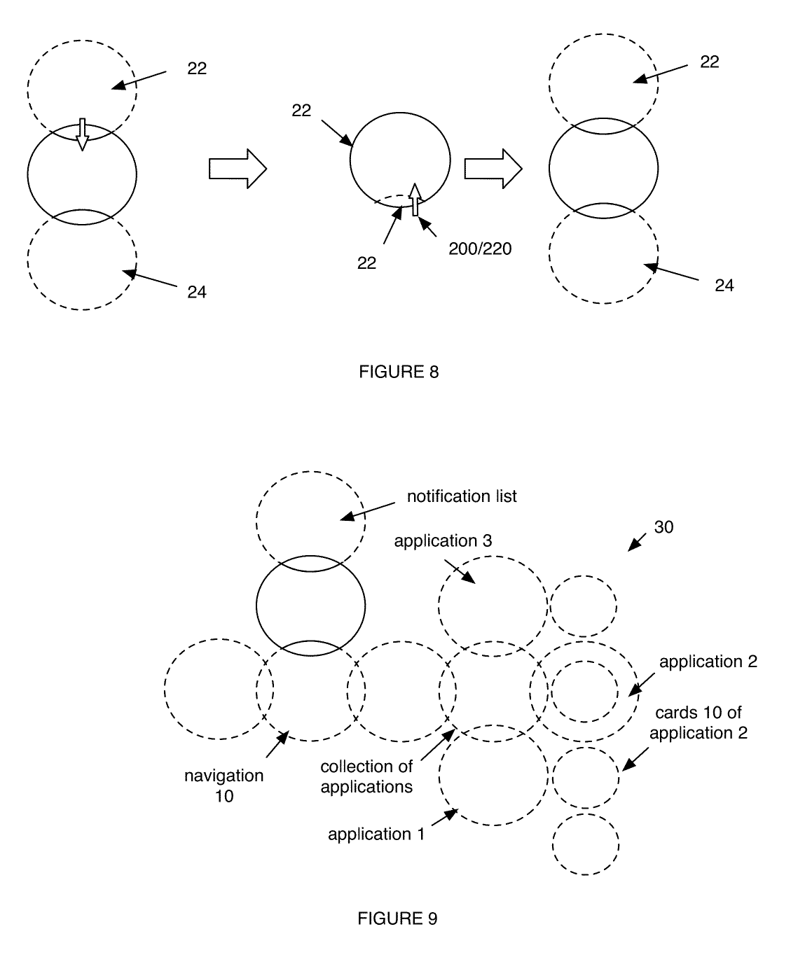

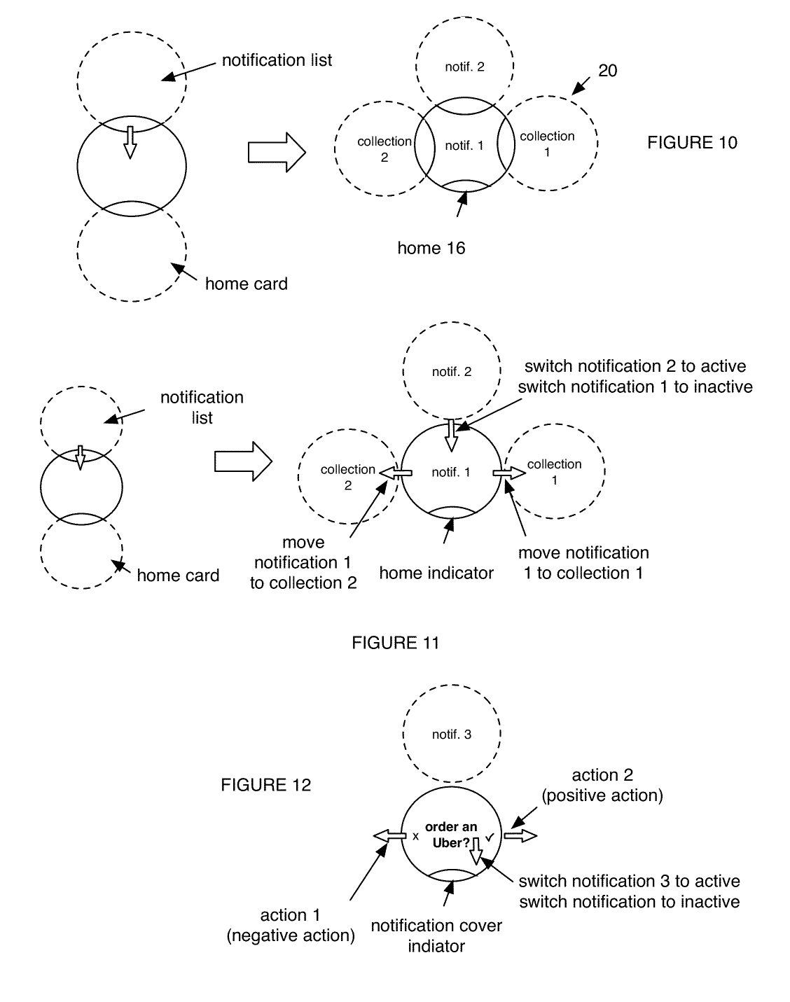

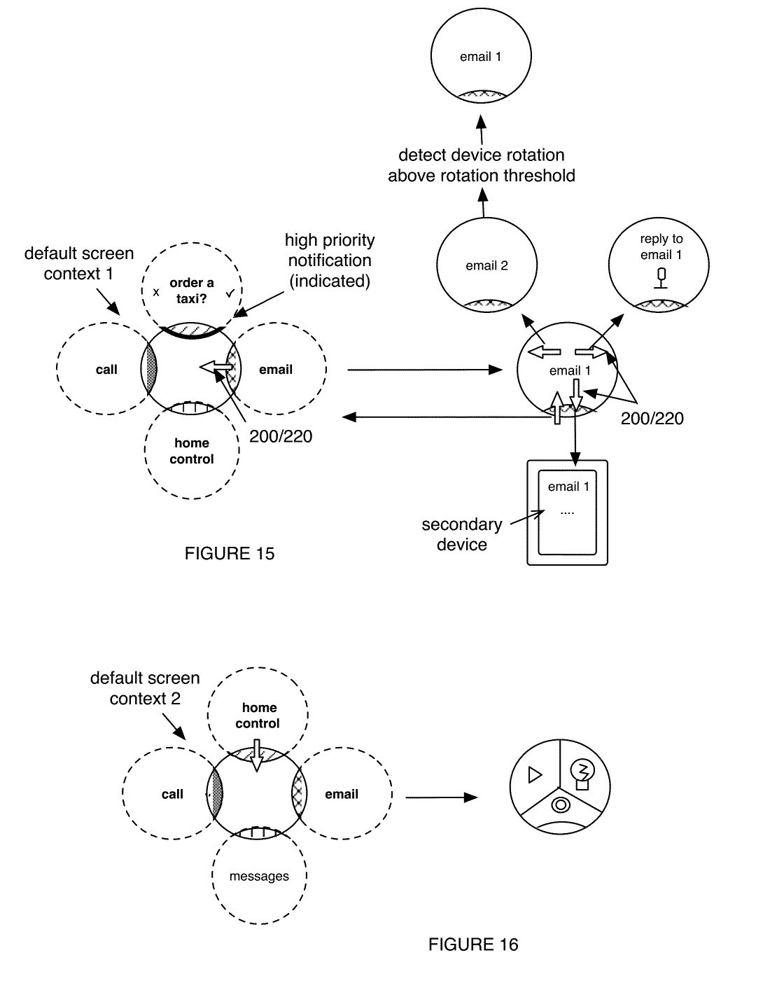

In a third embodiment of the method, a portion of each of a set of cards is concurrently displayed on the default screen. The cards are preferably displayed about the perimeter of the display, but can alternatively be displayed in the center of the display or displayed at any other suitable portion of the display. The set of cards are preferably automatically dynamically determined based on the substantially instantaneous context, but can alternatively be determined by the user or determined in any other suitable manner. The default card can be blank, can be a watch face, an image, video, or any other suitable visual content. A card of the set is preferably activated in response to receipt of a first gesture. The first gesture is preferably a radially inward gesture crossing the virtual threshold along a portion of the virtual threshold mapped to the respective card. However, the first gesture can be any other suitable gesture. In response to activation of the card, the remainder of the cards are preferably not rendered (e.g., hidden), as shown in FIG. 8. The card preferably occupies the entirety of the display. A card indicator that functions to identify the card or collection, such as an icon, pattern, or any other suitable indicator is preferably additionally rendered. The card indicator can be rendered at a position opposing the position at which the card was arranged on the prior default screen, wherein the active card indicator location is different for each card of the set, or can be rendered at a standard position of the display (e.g., aligned perpendicular to the second axis at the bottom of the display area). The card can be an information card, wherein a second gesture corresponds with a first action and a third gesture corresponds with a second action. For example, the card can be a suggested action card, wherein receipt of a radially outward gesture in a first direction (e.g., to the right) performs the suggested action, and receipt of a radially outward gesture in a second direction opposing the first direction (e.g., to the left) ignores or dismisses the suggested action. However, the card can be any other suitable information card. Alternatively, the card can be a group or application cover card, wherein the set of actions mapped to the set of gestures can be substantially similar to those corresponding to the group or application cover cards as described in the first embodiment. For example, a radially outward gesture along a first axis in a first direction can move the card of a first collection into a second collection arranged along the first axis in the first direction, and a radially outward gesture along the first axis in a second direction opposing the first direction can move the card of the first collection into a second collection arranged along the first axis in the second direction. The action performed on the information associated with a card is preferably reversed (e.g., the suggested action is undone and the suggested action card is rendered on the display, the card is moved from the second or third collection back to the first collection, etc.) in response to receipt of a macro interaction (e.g., rotation about a given axis above a predetermined frequency), a specific example of which is shown in FIG. 15. This can be desirable in this embodiment because application sub-collections, such as dismissed card collections, discarded card collections, or any other suitable sub-collections, are not concurrently rendered with the subsequent card. However, any other suitable actions can be mapped to any other suitable gestures for the cards.

The default screen is preferably rendered in response to receipt of a radially inward gesture crossing through the portion of the display or virtual threshold mapped to the active card indicator, but can alternatively be rendered in response to receipt of any other suitable interaction. Alternatively, the system and method can include any suitable combination of the aforementioned elements.

An alternative embodiment preferably implements the above methods in a computer-readable medium storing computer-readable instructions. The instructions are preferably executed by computer-executable components preferably integrated with a device computing system. The device computing system can include an interaction receiving system, an interaction mapping system that functions to map the interaction to an action based on the active card, and a transmission system that transmits the selected action to a remote device, such as a secondary device or a server. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for smartwatch control, comprising:
displaying a graphical representation of content within an active content stream on a display of a face of the smartwatch, the face comprising a radially symmetric profile and further comprising a touchscreen corresponding to and concentric with the display, wherein the display is smaller than the touchscreen, and wherein the touchscreen comprises a virtual threshold substantially tracing a perimeter of a visible portion of the display;
receiving a gesture at the touchscreen;
in response to the gesture originating radially outward of the virtual threshold and directed in a radially inward direction, setting a second content stream as the active content stream, wherein the second content stream is virtually positioned along a virtual axis in a first direction opposing the gesture direction relative to the first content stream;
in response to the gesture originating radially inward of the virtual threshold and directed in a radially outward direction, performing an action on the content of the active content stream based on a velocity of the gesture, comprising:
in response to the velocity falling below a velocity threshold:
displaying a list of actions associated with the active content stream on the display;
receiving a user selection of an action from the list of actions;
performing the selected action on the content;
storing the action in association with the active content stream; and
in response to the velocity exceeding the velocity threshold, performing the stored action on the content.

2. The method of claim 1, further comprising:
operating a notification component in response to receipt of the content at a first time;
monitoring a sensor for a signal indicative of user attention to the display;
in response to detection of a signal indicative of user attention to the display within a predetermined time period from the first time, setting the content stream associated with the content as the active content stream, wherein the graphical representation of the content is displayed in response to setting the content stream associated with the content as the active content stream; and
in response to absence of a signal indicative of user attention to the display within the predetermined time duration from the first time, retaining a second content stream as the active content stream.

3. The method of claim 2, wherein controlling the notification component comprises controlling a vibration component to vibrate.

4. The method of claim 2, wherein monitoring the sensor for the signal indicative of user attention to the display comprises monitoring a smartwatch accelerometer for a signal indicative of motion along a vector perpendicular the virtual axis.

5. The method of claim 2, wherein the second content stream comprises a default stream, wherein the default stream comprises a home screen, wherein the home screen comprises a background comprising graphical representations of a parameter of the first content stream over a time period.

6. The method of claim 5, wherein the background comprises a graphical rendering corresponding to a volume of notifications for each past hour within the time period, wherein the first stream comprises a notification stream.

7. The method of claim 1, wherein displaying the list of actions in response to the velocity falling below a velocity threshold comprises:
displaying a list of positive actions associated with the content stream in response to the gesture being directed in the first direction; and
displaying a list of negative actions associated with the content stream in response to the gesture being directed in a second direction opposing the first direction.

8. The method of claim 7, wherein the list of positive actions comprises executing a functionality requested by the content, and the list of negative actions comprises deleting the content from the smartwatch.

9. The method of claim 1, further comprising:
receiving content from a remote system;
temporally sorting the content, relative to an instantaneous time, into one of a plurality of content streams, wherein content associated with a time before the instantaneous time is assigned to a past content stream, and content associated with a time after the instantaneous time is assigned to a future content stream.

10. The method of claim 9, wherein the plurality of content streams are positioned in fixed virtual relation, wherein the second content stream comprises the past content stream, and is arranged to the left of a current content stream and the future content stream is arranged to the right of the current content stream, wherein setting a content stream of the plurality as active shifts the active content stream to coincide with the display and shifts the remainder of the content streams relative to the display to maintain the fixed virtual relation.

11. The method of claim 1, wherein the smartwatch is configured to couple to a watch band with the first axis substantially perpendicular a watch band longitudinal axis, the method further comprising performing an action on the instantaneously displayed content of the active stream in response to receipt of a radial gesture at an angle between the first axis and a second axis substantially parallel the longitudinal axis.

12. A method for smartwatch control, comprising:
displaying content from a first content stream at a radially symmetric face of the smartwatch, the face comprising a touchscreen coaxially arranged with a display;
tracking a user gesture at the touchscreen;
in response to user gesture categorization as a radially inward gesture, setting a second content stream as active, wherein the second content stream is different from the first content stream;
in response to user gesture categorization as a radially outward gesture:
determining a direction of the user gesture;
in response to the direction being a first direction, performing a positive action on the displayed content; and
in response to the direction being a second direction opposing the first, performing a negative action on the displayed content.

13. The method of claim 12, wherein the first and second directions are aligned along a first axis, the method further comprising: in response to the direction falling along a second axis, presenting secondary pieces of content within the first content stream in sequence.

14. The method of claim 13, wherein the touchscreen comprises a concentric virtual threshold proximal a touchscreen perimeter, wherein the user gesture is categorized as a radially inward gesture when the gesture originates radially outward of the virtual threshold and crosses the virtual threshold, and wherein the user gesture is categorized as a radially outward gesture when the gesture originates radially inward of the virtual threshold.

15. The method of claim 12, further comprising:
determining a velocity of the user gesture;
in response to the velocity falling below a threshold velocity:
presenting a list of actions associated with the content on the display and the gesture direction;
receiving a user selection of an action from the list of actions;
performing the selected action on the content; and
storing the action in association with the active content stream;
presenting a second piece of content from the active content stream at the display;
receiving a second user gesture at the touchscreen in association with the second piece of content;
determining a second velocity of the second user gesture; and
in response to the second velocity exceeding the threshold velocity, performing the selected action on the second piece of content.

16. The method of claim 15, further comprising, in response to the second velocity falling below the threshold velocity, presenting the list of actions on the display, receiving a second user selection of a second action from the list of actions, performing the second selected action on the second piece of content, and storing the second action in association with the active content stream.

17. The method of claim 12, wherein the second content stream is virtually positioned in fixed relation adjacent the first content stream, wherein setting the second content stream as active comprises displaying content within the second content stream.

18. The method of claim 17, further comprising:
receiving content from a remote system; and
temporally categorizing the content, relative to a reference time, into one of a plurality of content streams, wherein content associated with a time before the reference time is assigned to a past content stream, and content associated with a time after the reference time is assigned to a future content stream.

19. The method of claim 18, wherein the first content stream comprises a default stream, wherein the default stream comprises a home screen, wherein the home screen comprises a background comprising graphical representations of a parameter of the past content stream over a predetermined time period from the reference time.
